(19) United States
(12) Patent Application Publication
(10) Pub. No.: US 2024/0133672 A1
(43) Pub. Date: Apr. 25, 2024

(54) Solid-State Distinct-Unidirectional Photonic Interferometers for Collinear Velocity Detection

(71) Applicant: Val Parker, Ypsilanti, MI (US)

(72) Inventor: Val Parker, Ypsilanti, MI (US)

(21) Appl. No.: 17/973,147

(22) Filed: Oct. 24, 2022

(51) Int. Cl. G01B 9/02; G01P 3/36

(52) U.S. Cl. CPC G01B 9/02041; G01B 9/02034; G01P 3/36

(57) ABSTRACT

The Solid-State distinct-unidirectional photonic interferometer is an onboard opto-electronic navigational instrument that utilizes propagation of light within the instrument for continuously and independently, from other sources, detecting and measuring position, orientation, displacement, and rates of the displacement of an object in motion from within and from the motion itself.

### BACKGROUND OF THE INVENTION

### 1. The Field of the Present Invention

This invention relates generally to onboard navigational instrumentation, and more specifically to collinear apparatus for detecting and measuring position, orientation, displacement, and rates of the displacement of an object in motion.

### 2. General Background

For the purposes thereof, the terms “electromagnetic media”, “non-inertial media”, “light”, “beam of light”, “pulse of light”, “luminous flux” are equivalent unless otherwise stated. The terms “instruments”, “devices”, “apparatus” are similarly interchangeable. The terms “body”, “object”, “inertial frame”, “inertial system” are similarly, interchangeable. The terms “collinear”, “in-line”, “linearly”, “rectilinear”, are similarly interchangeable.

References made in the English measurement system are hereafter assumed to include their metric equivalent values and vice versa.

The prior art includes various types of apparatus to provide comparative measurements of light propagation in such devices as fiber optic and laser gyros.

All of these devices are using photonic circuits that compare exclusively changes in position, orientation, and speeds via rotation and/or acceleration. This approach to measurements has serious shortcomings, the most significant of which is that they cannot provide simultaneous continuous information on speed and direction of displacement from direct onboard readings of an individual instrument. Some of such devices, including solid-state interferometers, comprise the combination of separate elements such as Lithium-Niobate modulators, Fiber Optic coils, and elements of interconnected architecture.

The field of silicon photonics is gaining significant momentum because it allows photonic devices to be made cheaply using standard semiconductor fabrication techniques and integrated with microelectronic chips.

CMOS-compatible silicon photonic modulators with high modulation speeds, large bandwidths, small footprints, low losses, and ultralow-power consumption are developed on highly integrated on-chip photonic circuits. The successful development of silicon photonic modulators, germanium on silicon photodetectors, and on-a-chip lasers in conjunction with low loss silicon waveguides became the base for the development of on-chip slow-light photonic devices as described in the present invention.

### SUMMARY OF THE INVENTION

The present invention is a solid-state distinct unidirectional photonic interferometer having its elements constructed within common technological processes.

Thus, the interferometer has a feature of stable operation at significant reductions in space, power, and cost to manufacture.

Advantages of this invention include its ability to provide for high-resolution measurements of delay in light propagation through different branches, utilizing collinear unidirectional time delay elements that are the intricate parts of the common solid-state substrate.

The above and other objects, features, and advantages of the present invention will be apparent from the following detailed description of the preferred embodiments of the present invention in connection with the accompanying drawings.

In one embodiment, this invention interferometer includes an emitter, a modulator, and a receiver/demodulator separated by the dual branch photonic circuitry that provides the time delays of light beams and correlated changes of light characteristic of said light beams along the paths of the light propagation through the circuits. The beam of light said emitter from the emitter and modulated at the modulator is split at the beam splitter into two beams of light, each of which propagates in its own branch. The light beam in each branch is passing through the unidirectional time delays element. The light in the unidirectional time delays element is propagated at an angle to the light propagation in all other elements of the photonic circuitry. Further, the light beam from the unidirectional time delays element is joined by the light beam emitted from the light emitter at the recombiner before entering into the detector that provides demodulation of the light beam.

The speed of light is slowing by the solid-state unidirectional time delay in relation to the axis of travel of the collinear velocity detectors. Since the speed of light in solid-state elements of the interferometer continue to be constant, so the time of light travel to the detector where physical characteristics of both beams will provide for high-resolution interferometric measurements of the displacement of its own physical structure i.e. collinear velocity detector, as well as the physical structure it is attached to.

In other embodiment, this invention interferometer includes an emitter and a detector facing each other on a common optical axis. The beam of light from said emitter is split at the beam splitter into two beams of light, each of which further modulated at given frequencies by the modulators. Both beams of light correspondingly are passing through the collinear unidirectional time delays elements. In both time delay elements, the light beams propagate at an angle to the emitter-receiver optical axis and in the counter direction to each other. Further, both beams recombined at the detector.

In another embodiment, this invention interferometer includes an emitter, a three ways splitter, a modulator, and two branches each of which contains a collinear unidirectional time delays element, a combiner, and a detector to demodulate light, and a detector to affect electronic signals from both branches.

In another embodiment, the system contains two pairs of the light emitter and receiver/demodulators with conjoint modulators/time delay circuitry. Two filter-receivers' systems provide that each receiver is matched with the correlated emitter.

In another embodiment, a light beam undergoes variable time delay adjustments in one of the time delay elements. The delay of time in each of the time delay elements is proportional to the characteristics of said delay elements. The output from each said time delay element is recombining with the light beam of the oppositely placed time delay element at the correlated receiver, providing for scaling of the output information.

In yet another embodiment, the system contains an additional light beam profile generating device to direct the light beam emitter to generate a light beam of a specific pattern, e.g. serrodyne, square, sinusoidal, etc. . . . .

In another embodiment, the multiple interferometers with the common laser are placed at an angle to each other, thus providing measurements along separate axes.

### BRIEF DESCRIPTION OF DRAWINGS

FIG. 1 shows one type of interferometer system of my invention, including an emitter, a modulator, a light splitter to split light beam in two branches, where each branch of the dual branch system consists of a collinear unidirectional time delay element, a light combiner to combine light from the time delay and the light emitted from the light emitter at the detectors.

FIG. 2 is similar to FIG. 1 with a set of light beam modulators and a set of collinear unidirectional time delay elements in both branches of the system

FIG. 3 shows the interferometer system in which an emitter and a receiver are split into two branches where each branch is comprised of a modulator, a time delay and a detector, and an independent from the both branched detectors.

FIG. 4 shows another type of interferometer system in which a pair of emitters is connected with the pair of filter/detectors by the means of light combiner/splitters with every branch contains a modulator and a time delay element.

FIG. 5 shows a time delay design with multiple outputs,

FIG. 6 shows an element of an optic circuit where a light beam profile generating device is connected to the emitter

FIG. 7 shows a combination of two interferometers having a common laser and placed at an angle to each other

FIG. 8 shows a combination of three interferometers having a common laser and placed at an angle to each other

FIG. 9 shows an element of a system having a temperature control for the system and the power control for the emitter

FIG. 10 shows the interferometer system in which post emitter elements are split into two branches where each branch is comprised of a modulator, a time delay, and a detector

The foregoing description of the preferred embodiment of this invention is illustrative. The concept and scope of this invention are not limited by such details but only by the following claims.

### DETAIL DESCRIPTION OF DRAWINGS

Two principles provide the basis for this invention:
Principle (1): Light travels in any media with constant speed which is independent of the speed of said media in which it propagates;
Principle (2): The wave nature of light provides for the interferometric nature of measurements in comparing one beam of light with the other

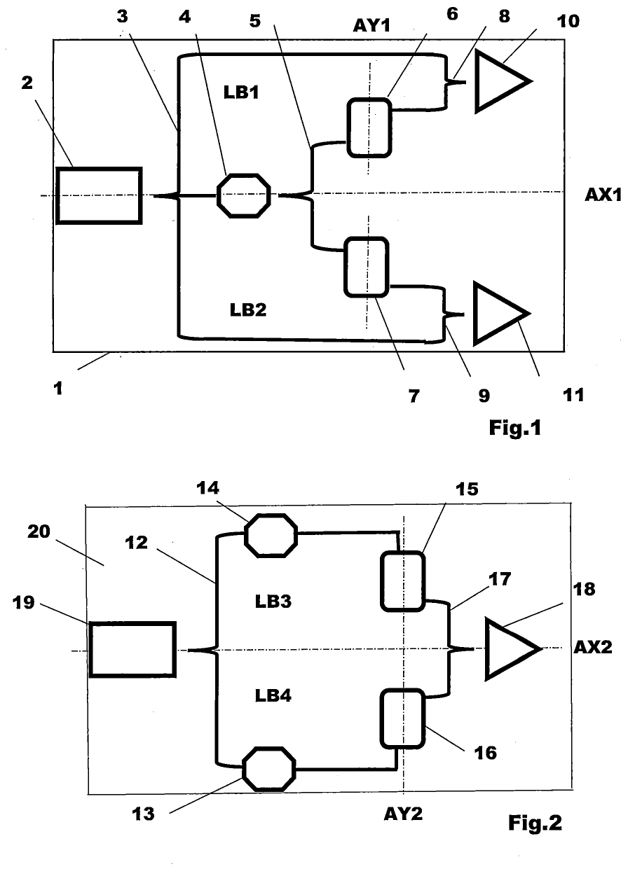

In FIG. 1, a solid-state interferometer 1 includes a light emitter 2, a light beam splitter 3, a light modulator 4, a beam splitter 5, a unidirectional time delay element 6 in LB1 branch, a unidirectional time delay element 7 in LB2 branch, a light combiner 8 in LB1 branch, a light combiner 9 in LB2 branch, a light detector 10 in LB1 branch, and a light detector 11 in LB2 branch. While light emitter 2, light modulator 4, light receiver 10, and light receiver 11 are aligned along emitter/receiver axis AX1, unidirectional time delay elements 6 and 7 are aligned along axis AY1 that is at an angle to emitter/receiver AX1 axis. At that, every motion of the interferometer 1 along the time delays axis AY1 influences the distance the light travels inside of the time unidirectional time delay elements, which is measurable in times of lights arrivals at detector 10 and 11. The travel times of lights inside of the unidirectional time delay elements are proportional to the characteristics of the unidirectional time delay element and the velocity with which the interferometer 1 is moving.

In FIG. 2, solid-state interferometer circuit 20 includes a light emitter 19, a light beam splitter 12, a light modulator 14 in LB3 branch, a light modulator 13 in LB4 branch, a unidirectional time delay element 15 in LB3 branch, a unidirectional time delay element 16 in LB4 branch, a light combiner 17, a detector 18. While light emitter 19, light modulator 14, light modulator 13, and receiver 18 are aligned along emitter/detector axis AX2, unidirectional time delay elements 15 and 16 are aligned along axis AY2 that is at an angle to emitter/receiver AX2 axis and light travels in both time delay elements 15 and 16 in opposite direction to each other. The travel times of lights inside of the time delay elements are proportional to the characteristics of the time delay elements and the velocity with which the interferometer 19 is moving. Because light travels in time delay elements 15 in opposite direction to the light path in time delay elements 16, the summation of the time delay at receiver 18 will show the difference.

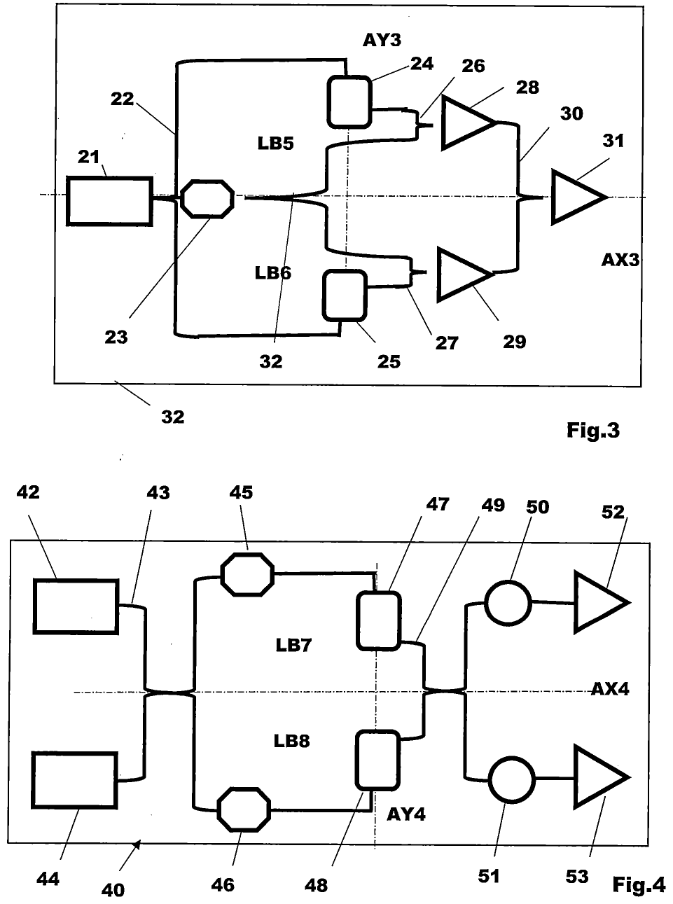

In FIG. 3 a solid-state interferometer 32 includes a light emitter 21, a light beam splitter 22, a light modulator 23, a unidirectional time delay element 24 in LB5 branch, a unidirectional time delay element 25 in LB6 branch, a light combiner 26 in LB5 branch, a light combiner 27 in LB6 branch, a light detector 28 in LB5 branch, a light detector 29 in LB6 branch, a light splitter 32, an electronic signal combiner 30 and a detector 31. Unidirectional time delay elements 24 and 25 are aligned along axis AY3 that is at an angle to optoelectronic elements of the circuit. The travel times of lights inside of the time delay elements are proportional to the characteristics of the time delay elements and the velocity with which the interferometer 32 is moving. Because light travels in time delay elements 24 in opposite direction to the light path in time delay elements 25, the summation of the time delay at detectors 22 and 29 will show the difference. An unmodulated light travel from light emitter 21 via splitter 22 to light detectors 28 and 29 providing demodulation of the modulated lights at light detectors 28 and 29. Further, electronic signals, from detectors 28 and 29 are recombined via electronic signal combiner 30 and compared at detector 31.

In FIG. 4 a solid-state interferometer circuit a first emitter 42, a second emitter 44, a splitter/combiner 43, a light modulator 45 in LB7 branches, a light modulator 46 in LB8 branch, a unidirectional time delay element 47 in LB7 branch, a unidirectional time delay element 48 in LB8 branch, a light combiner/splitter 49, a filter 50 in LB7 branch that corresponds to the frequency of emitter 42, a filter 51 in LB8 branch that corresponds to the frequency of emitter 44, a receiver 52 in LB7 branch, and a receiver 53 in LB8 branch.

The combination of the pair of emitters 42 and 44 and corresponding filter 50 and 51 and receivers 52 and 53 provides for the flexibility of measuring the velocity with which the interferometer is moving along the time delay elements' axis AY4.

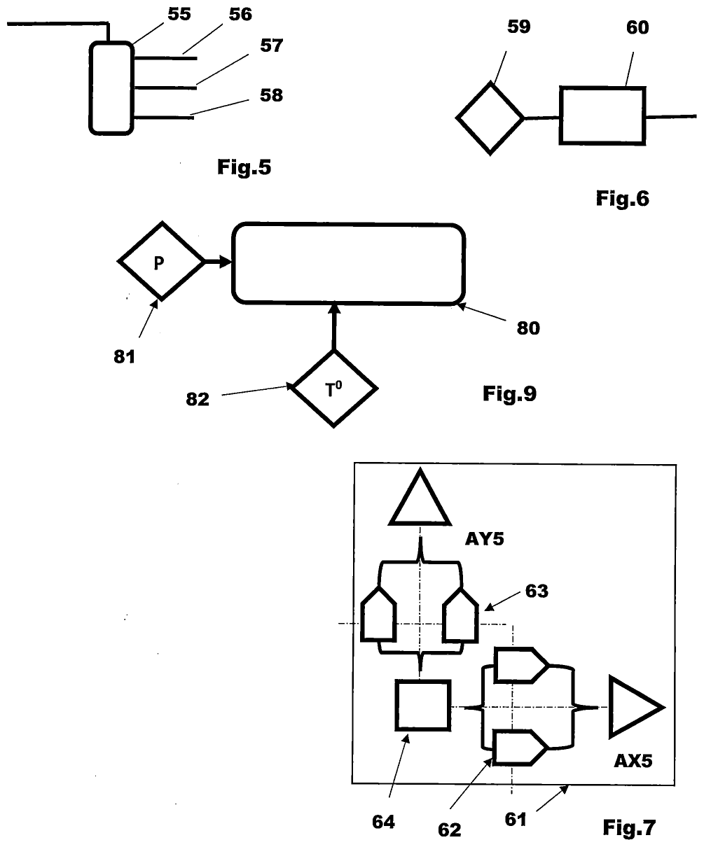

FIG. 5, shows the element of interferometer that includes a unidirectional time delay element 55 with multiple outputs 56, 57,58 that correspond to different time delays, providing the flexibility of measuring timed delays at composing sequences.

FIG. 6 shows the element of interferometer that includes a light beam profile generating device 59 and a light emitter 60. Beam profile generating device 59 provides emitter 60 with the ability to generate light of a specific pattern, e.g., serrodyne, square, sinusoidal, etc.

In FIG. 7, device 61 comprised of a solid-state interferometer 62 and a solid-state interferometer 63 having a common light emitter 64 and placed at an angle to each other along AX5 and AY5 axes. Unidirectional design of each system provides for measurements of velocities in the corresponding axis.

In FIG. 8, device 70 comprised of a solid-state interferometer 71, a solid-state interferometer 72, and solid-state interferometer 73 having a common light emitter 74 and placed at an angle to each other along AX6, AY6, and AZ6 axes. Unidirectional design of each system provides for measurements of velocities in the corresponding axis.

In FIG. 9 an interferometer 80 is electronically connected to a power supply 81 and electromechanically connected to a thermal control 82.

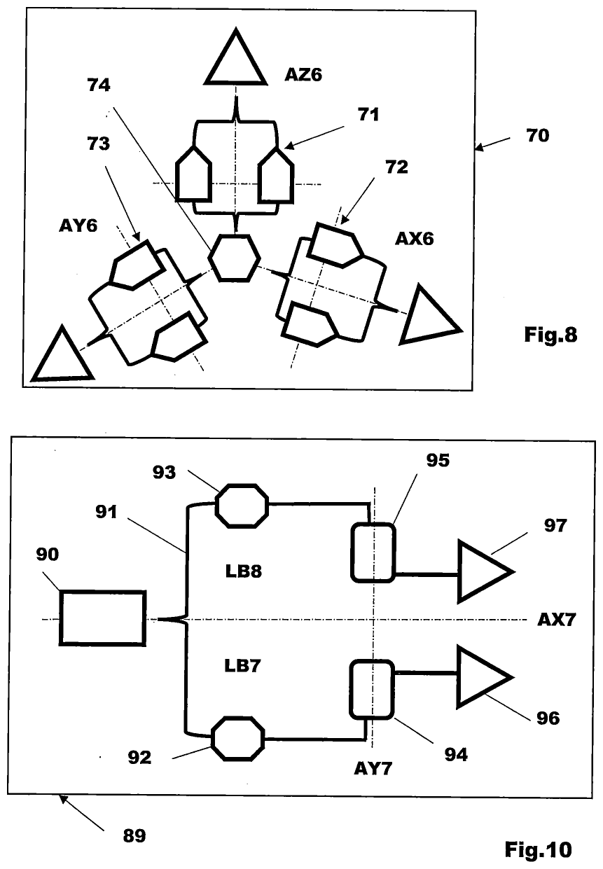

In FIG. 10, solid-state interferometer circuit 89 includes a light emitter 90, a light beam splitter 91, a light modulator 92 in LB8 branch, a light modulator 92 in LB7 branch, a unidirectional time delay element 95 in LB8 branch, a unidirectional time delay element 94 in LB7 branch, a detector 97 in LB8 branch, and a detector 96 in LB7 branch. While light emitter 90, light modulator 92, light modulator 93, receiver 97, and receiver 96 are aligned along emitter/detector axis AX7, unidirectional time delay elements 95 and 94 are aligned along axis AY7 that is at an angle to emitter/receiver AX7 axis and light travels in both time delay elements 95 and 94 in opposite direction to each other. The travel times of lights inside of the time delay elements are proportional to the characteristics of the time delay elements and the velocity with which the interferometer 89 is moving. Because light travels in time delay elements 95 in opposite direction to the light path in time delay elements 94.

1. Solid-state photonic interferometer to detect and determine differences in the parameters of the beams of light that propagate collinearly in the separate branches therein said system including
a light beam emitter, locate on the common substrate to emit light along an optical axis;
a solid-state beam splitter located on the common substrate on said optical axis to split said beam of light from the emitter into two predetermine light beams
a light modulator, located the common substrate on the said optical axis to modulate light emitted from the light beam emitter at a predetermined frequency
a unidirectional solid-state time delay element located on the branch on the same substrate at predetermine angle to the main light beam circuitry to slow propagation of the light beam in the chosen direction and at a predetermined time delay
a unidirectional solid-state time delay element located on the same substrate on the other branch on the same substrate at predetermine angle to the main light beam circuitry to slow propagation of the light beam in the chosen direction and at predetermine time delay
a solid-state light beam combiner located on the same substrate on one of the branches on the common substrate on the said optical axis to recombine light beams from said light emitted from said emitter and the time delay of one of the branches
a solid-state light beam combiner located on the same substrate in the branches on the common substrate on the said optical axis to recombine light beams from said light emitted from said emitter and the time delay of one of the branches
a solid-state light detector located on the same substrate in one of the branches on the common substrate on the said optical axis at a fixed distance from the said emitter to receive and demodulate light therefrom
a solid-state light detector located on the same substrate in the other branch on the common substrate on the said optical axis at a fixed distance from said emitter to receive and demodulate light therefrom

2. A solid-state interferometer according to the claim 1 wherein said
a complex dual branch solid-state light circuitry located on the common substrate on said common optical axis that consists of:
a pair of light emitters to emit light into common optical circuitry
a solid-state splitter to split light in three ways to direct said light into two different branches and further into the other splitter
two branches of similar elements that consist:
a solid-state light modulator, located in the common substrate in one branch, to modulate light emitted from the light beam emitter at a predetermined frequency
a unidirectional solid-state time delay element on the same branch as the modulator, on the same substrate at predetermine angle to the main light beam circuitry to slow propagation of the light beam in the chosen direction and at predetermine time delay
a solid-state light detector on the same branched on the common substrate at a fixed distance from said emitter to receive and demodulate by the menace of recombining said light from the modulator and non-modulated light from said emitter
a combiner to combine electric signals from said two detectors from said two branches
a detector of electronic signals on the common substrate at a fixed distance from said emitter to receive and compare by the menace of recombining said electronic signals from said both branches.

3. A solid-state interferometer according to the claim 1 wherein said
each one of the solid-state unidirectional time delays elements are made to be variable providing the number of outputs in correlation with required time delays

4. A solid-state interferometer according to the claim 1 wherein said
a complex dual branch solid-state light circuitry located on the common substrate on said common optical axis that consists of:
a pair of the light emitter to emit light into common optical circuitry
a solid-state combiner-splitter to recombine light from both light emitters and further split the light to direct said light into different branches
a solid-state light modulator, located in the common substrate in one branch of the splitter beam, to modulate light emitted from the light beam emitter at a predetermined frequency a unidirectional solid-state time delay element on the same branch as the modulator, on the same substrate at predetermine angle to the main light beam circuitry to slow propagation of the light beam in the chosen direction and at predetermine time delay
a solid-state light modulator, located in the common substrate in the other branch of the beam splitter, to modulate light emitted from the light beam emitter at a predetermined frequency a unidirectional solid-state time delay on the same branch as the other modulator located on the same substrate at predetermine angle to the main light beam circuitry to slow propagation of the light beam in the chosen direction and at a predetermined time delay
a complex solid-state light combiner-splitter located on the common substrate on the said optical axis to recombine light from both light branches and further split said light into different branches
a system of solid-state filter-detectors on each branch located on the common substrate to filter incoming light that is correlated with said required parameter of therein receivers

5. A solid-state interferometer according to the claim 1 wherein said
a light emitter, a light modulator and a detector of electronic signals on the common substrate at a fixed distance from said emitter to receive and compare by the menace of recombining said electronic signals from said both branches
a solid-state splitter to split the light to direct said light into different branches and said the light modulator
a solid-state light modulator, located in the common substrate, to modulate light emitted from the light beam emitter at a predetermined frequency
a complex dual branch solid-state light circuitry located on the common substrate on said common optical axis that similarly consists of:
a unidirectional solid-state time delay element on the same substrate at predetermine angle to the main light beam circuitry to slow propagation of the light beam in the chosen direction and at a predetermined time delay
a solid-state light detector located on the same substrate in one of the branches on the common substrate on the said optical axis at a fixed distance from the said emitter to receive and demodulate light therefrom
a solid-state complex light splitter/combiner located on the common substrate on the said optical axis to split the light from the modulator and recombine the light from the modulator with light from the time delay on each of the branches and feed the recombined light in the solid-state light detector in the each of the branches
a combiner to combine electric signals from said two detectors from said two branches
a detector of electronic signals on the common substrate at a fixed distance from said emitter to receive and compare by the menace of recombining said electronic signals from said both branches.

6. A solid-state interferometer according to the claim 1 wherein said
a light beam profile generating device is incorporated to direct the light beam emitter to generate a light beam of a specific pattern, e.g. serrodyne, square, sinusoidal, etc. . . . .

7. A solid-state interferometer according to the claim 1, 2, 3, 4 wherein said a beam in one branch of the beam splitter is rotated in relation to the other branch, producing the time differential input in the solid-state combiner

8. A solid-state optical interferometer to detect and determine differences in the parameters of the beams of light that propagate collinearly within the separate branches that are at an angle to each other on the same substrate, therein said system including
a solid-state interferometer placed along with one of the said axes
a solid-state interferometer place along the other said axis that is at an angle to the other
a common light beam emitter to emit light along the optical axis of each of said interferometers

9. A solid-state interferometer according to claims 1, 2,3,4, wherein said each branch has its own unidirectional time delay system where said light is traveling in opposite directions in relation to each other.

10. A solid-state interferometer according to the claim 1, 2, 3, 4, 5, 6,7, 8 having temperature control to respond to the change of thermal conditions.
